(19) United States
(12) Patent Application Publication
(10) Pub. No.: US 2006/0048884 A1
(43) Pub. Date: Mar. 9, 2006

(54) Tire building method and stitcher device

(76) Inventors: Shigeo Kudo, Osaka (JP); Tetsuo Tatara, Osaka (JP); Masami Tanabe, Osaka (JP)

Correspondence Address: JORDAN AND HAMBURG LLP, 122 EAST 42ND STREET, SUITE 4000, NEW YORK, NY, 10168, US

(21) Appl. No.: 11/135,070

(22) Filed: May 23, 2005

(30) Foreign Application Priority Data
Sep. 8, 2004 (JP) 2004-261663

(51) Int. Cl. B29D 30/14; B29D 30/28

(52) U.S. Cl. 156/130.3; 156/412; 156/421

(57) ABSTRACT

A tire building method and a stitcher device therefore, which are aiming for achieving reliable pressing for bonding between a plurality of tire members all over outer face of the tire members, without forming a void between them, even though the outer face of the tire members have ups and downs, so as to curb strain in a carcass cord and to improve process efficiency. The method comprising: laying one or more of the tire members on a rotary support body such as a building drum; and press-contacting a press-contact part of a stitcher device on said one or more of the tire members on the rotary support while the rotary support being rotated, so as to bond together said one or more of the tire members; said press-contact part being a pneumatic-tire roller maintained with a certain level of inner pressure.

### TECHNICAL FIELD

The present invention relates to a tire building method and a stitcher device which is used in the tire building method.

### BACKGROUND ART

Conventionally, as a building method of tires, there has been known a two-stage building method for building a tire. Plase see, for example, JP-A-1995-60868 and JP-A-2003-231187. The two-stage building method is as follows: Inner tire members such as an inner liner, a chafer, carcass plies and the like are laid to be stacked on a building drum capable of expanding and shrinking a diameter thereof, as to form a cylindrical laminate of the inner tire members. Onto this inner-member cylindrical laminate, made are a setting of beads, turn-up folding of the carcass plies, stacking of side wall rubbers and the like as to build an inner-member laminate which is referred to as a “green casing” and also as a “carcass green”. The inner-member laminate is transferred to a second building drum and is deformed into a toroidal shape by bulging. Then, outer tire members such as a belt, a tread rubber and the like are stacked onto outer face of such deformed inner-member laminate, as to build a “green tire” or a to-be-vulcanized tire.

There has been also known a case where the outer tire members such as the belt, the tread rubber and the like are stacked to be laminated on the building drum separately from the cylindrical inner-member laminate or “carcass green”. Then, such a laminated cylinder of tire outer members is stacked on outer face of the inner-member laminate or the “caracass green”.

Meanwhile, when the inner-member laminate is built by stacking a plurality of tire inner members at the same building position, a building cycle time is prolonged and this obstructs the enhancement of the productivity. In view of this, there has been also proposed a method in which a plurality of movable rotary support bodies such as building drums are used and these rotary support bodies are transferred to given building positions corresponding to the respective tire members, at which the member is stacked or built and/or formed.

Among the plurality of members for building the tire, the rubber members solely consisting of rubber material, such as the inner liner, the tread rubber and the side wall rubber, are extruded from dies of extruders to be molded in a cross-sectional shapes of these rubber members and then cut into predetermined sizes. By such extrusion, there arise drawbacks such as the distortion and the shrinkage of the members. In view of this, JP-A-2000-202921 and JP-A-1997-29858 propose a method in which a to-be-vulcanized rubber is extruded and wound around the rotary support body such as the building drum in a spirally overlapped manner to build a rubber member having a given cross-sectional shape. The sidewall rubber may be formed by stacking the rubber ribbon onto the above-mentioned cylindrical building body that is deformed as bulged.

At building the green tire, to obtain the favorable quality of the tire as a product, it is very important to ensure the adhesion between the tire members stacked to each other as to prevent generation of air-retaining voids at inside of rubber member.

For example, the outer tire members such as the belt, the tread rubber and the like are stacked on the cylindrical inner-member laminate or the “carcass green” and the like as follows. The cylindrical inner-member laminate is supported on the rotary support body and is deformed as bulged with maintaining a fixed inner pressure; and in such state, the outer tire members are stacked on the inner-member laminate. Thereafter, the outer tire members are pressed to be bonded onto the inner-member laminate by a stitcher device. Please see JP-A-1995-60868. Here, it is necessary to surely perform the pressing for bonding.

Conventionally, the stitcher device includes a pressing member which is brought into contact with the tire members, wherein the pressing member is constituted of a stitching roller made of a hard material such as metal or synthetic resin or the like. By moving the stitching roller in the widthwise direction from a crown portion to side wall portions, for example, the tire members are pressed and bonded to the inner-member laminate.

FIG. 6 shows a state in which the tire members are pressed by a conventional stitching roller 111. In the drawing, numeral 101 indicates an inner-member laminate that is comprised of an inner liner 101a, carcass plies 101b and the like; numeral 102 indicates a side wall rubber; numeral 103 indicates a belt; numeral 104 indicates a tread rubber; and numeral 105 indicates a green tire that is formed by stacking the outer tire members onto the inner-member laminate. Numeral 106 indicates a bead portion; numeral 106a indicates a bead core; and numeral 108 indicates a rotary support body such as a building drum.

The stitching roller 111 for the pressing in the conventional stitcher device is formed of a hard material. Thus, applying of a uniform pressure all over the tire members is almost impossible; due to surface unevenness of carcass ply layers in the inner-member laminate 101, as well as to the outer surface unevenness of the outer tire members stacked on the inner-member laminate, and to the deviation in reaction force arisen from an inner pressure of the cylindrical inner-member laminate 101 that is caused by deviation in stiffness of the tire members, or the like.

Further, in view of the surface unevenness and deviation of the reaction force, the stitching roller 111 for the press bonding has a relatively narrow width of about 10 mm at most as to have a small pressing area and thereby to leave a line-wise pressed area in a circumferential direction; in order for facilitating bonding of the stacked tire members on the inner-member laminate 101.

Accordingly, it is necessary to keep down a widthwise-moving speed of the stitching roller 111, and to take large overlapping margins on circumferential pressing lines. This should prolong the pressing time by the roller 111 when to press the tire members over a wide range. Consequently, tire building cycle time is prolonged thus obstructing the enhancement of the productivity. On top of the above-mentioned drawbacks, the roller 111 made of the hard material gives rise to the local and non-resilient pressing; thus generating the forced deformation of a profile of to-be-vulcanized rubber and distortion of the carcass cord. As a result, the uniformity of tire product is adversely affected.

Particularly, when ribbons of rubber material is extruded and spirally wound as overlapped in a tire circumferential direction as to form a tire's rubber member having a certain profile, the ribbons of relatively small size are pressed. Thus, the ribbons are susceptible to deformation as to undermine stability in layout of the tire members in tire building; and improvement in the tire building method is required.

In view of the above, it is aimed to provide a tire building method able to reduce deformation and distortion of a carcass cord at a time of bonding the outer tire members such as a belt, a tread rubber and the like onto inner tire members such as inner liners, carcass plies and the like; and thereby, enabling reliable press-wise bonding without causing an air-retaining void all over the periphery of the tire members. It is also aimed to provide a stitcher for such a tire building method.

### SUMMARY OF THE INVENTION

An invention-wise method for building a green tire by stacking and bonding together a plurality of tire members, comprises; laying one or more of the tire members on a rotary support body such as a building drum; and press-contacting a press-contact part of a stitcher device on said one or more of the tire members on the rotary support while the rotary support being rotated, so as to bond together said one or more of the tire members, said press-contact part being a pneumatic-tire roller maintained with a certain level of inner pressure.

In the above method, the pressing part or member of the stitcher device for pressing and bonding the tire members is formd of pneumatic-tire roller and hence, the pressing is made at an approximately uniform pressing force over the whole pressing surface by way of inner pressure of the pneumatic-tire roller. Thus, even when a width of the roller is increased, there arises no difference in the pressing force within the pressing surface and the pressing area may be increased without any problem. Accordingly, a moving speed of the roller when the roller is to be moved in the widthwise direction may be increased and hence, even when the pressing for the bonding are to be applied on whole of tire members in a large area. Such pressing for the bonding may be preformed in a short time, whereby a building cycle time is shortened thus contributing to the enhancement of the productivity.

Because the pneumatic-tire roller used as the pressing member has a proper resiliency on a pressing surface thereof, the pressing member absorbs; for example, the unevenness of the surface of the carcass plies of the inner-member laminate; and the unevenness of outer peripheral surface of a plurality of tire members which are stacked on the carcass plies and the like. Thus the pressing is made almost uniformly without forming a void, allover the surface of the tire. Accordingly, deformation or distortion of the carcass cord, for example, is curbed or alleviated; and hence, uniformity of the tire is not adversely affected at the pressing process.

Because the use of the pneumatic-tire roller makes the pressing force uniform, layout and dimensions of the tire members are not deviated from designed ones. Thus, it is easy, for example, to cope with change or modification of tire profile at a trial production stage and the time required for the development of the tire is largely shortened.

In a preferred embodiment, the method for building a green tire, further comprises: forming a cylindrical laminate of inner tire members such as an inner liner, a carcass ply; processing on the cylindrical laminate such as bead setting, turn-up folding of the carcass ply and laying of sidewall rubber; deforming the cylindrical laminate as bulged to take a toroidal shape; and laying of outer tire members such as a belt and a tread rubber before said press-contacting. By this way, favorable forming of the tire is achieved without generating deformation of the profile of the tire members and deformation and distortion of the carcass cord, as mentioned before.

In another preferred embodiment, the method for building a green tire, further comprises: forming a rubber member such as an inner liner, sidewall rubber and tread rubber by winding a rubber ribbon on the rotary support, before said press-contacting. By this way, even though the press-contacting is made on a relatively small rubber strip or rubber ribbon, excessive deformation or distortion is curbed to achieve stable forming of the tire.

In a further preferred embodiment, the method for building a green tire, further comprises: adjusting the inner pressure depending on the tire member; and controlling supply of gas to inside of the neumatic-tire roller as to maintanin the certain level of inner pressure during said press-contacting. Because the inner pressure of the pneumatic-tire roller is being adjusted, even when the pressing surface of the roller is resiliently deformed, it is able to maintain the pressing force at a fixed value. Thus, the tire members are pressed and bonded in a well-balanced manner as a whole; whereby it is able to further effectively suppress the generation of the deformation and the distortion of the profile of the tire members thus eliminating the possibility that the uniformity of tire is deteriorated.

Invention-wise stitcher device, which is for pressing one or more tire members laid on a rotary support such as a building drum to achieve bonding of rubber in forming a green tire, comprises; a pneumatic-tire roller as a part for press-contacting on outer face of the tire member as to achieve said bonding, the pneumatic-tire roller being maintained with a certain level of inner pressure.

By such a stitcher device, in a manner as mentioned above, deformation or distortion of a carcass cord is reduced or eased, for example, which is generated at a time when outer tire members such as a belt, a tread rubber and the like are bonded onto inner members of the tire. Moreover, even though outer faces of the tire members have ups and downs or unevenness, the tire members are bonded together without forming a void, in a reliable manner all over the tire's surface.

In a preferred embodiment, the stitcher device further comprises; an actuator attaching and holding the pneumatic-tire roller as to be movable in a direction substantially perpendicular to outer face of the tire member laid on the rotary support; and the pneumatic-tire roller being movable in a direction substantially along axis of the rotary support. In this way, the pneumatic-tire roller presses the outer face of the tire member laminate over a large area and hence, the tire members are surely bonded together.

In a further preferred embodiment of the stitchre device, the pneumatic-tire roller is attached to moving part of the actuator; and the actuator is controlled such that, during said press-contacting, a distance between axis of the pneumatic-tire roller and said outer face is maintained to be constant. In this way, pressing force exerted on the outer face of the tire members is kept constant.

In another preferred embodiment, the stitchre device further comrises: a gas supply system connected to a hollow inside of the pneumatic-tire roller; and a pressure switch provided at a portion of a gas supply line from the gas supply system and capable of detecting the inner pressure; gas supply through the pressure switch being controlled based on said detecting as to keep the inner pressure as constant. In this way, the press-contacting is made with a constant pressure and in a well-balanced manner all over the outer face of the tire.

### BRIEF DESCRIPTION OF THE DRAWINGS

FIG. 1 is a vertical cross-sectional and front view schematically showing an essential part of an embodiment of the present invention;

FIG. 2 is a schematic side view of the embodiment;

FIG. 3 is an enlarged cross-sectional view of a stitcher device in the embodiment of present invention;

FIG. 4 is an explanatory view for showing a manner of pressing by the stitcher device with a pneumatic-tire roller;

FIG. 5 is a circuit diagram for an inner pressure control by filling a gas into a pneumatic-tire roller; and

FIG. 6 is an explanatory view for showing a manner of pressing by a conventional stitching roller.

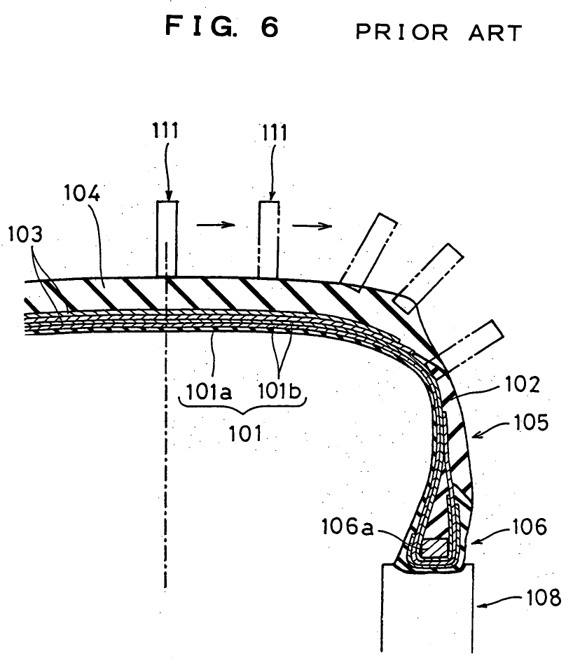

### DETAILED DESCRIPTION OF THE INVENTION

An embodiment of the present invention explained hereinafter, in conjunction with the drawings.

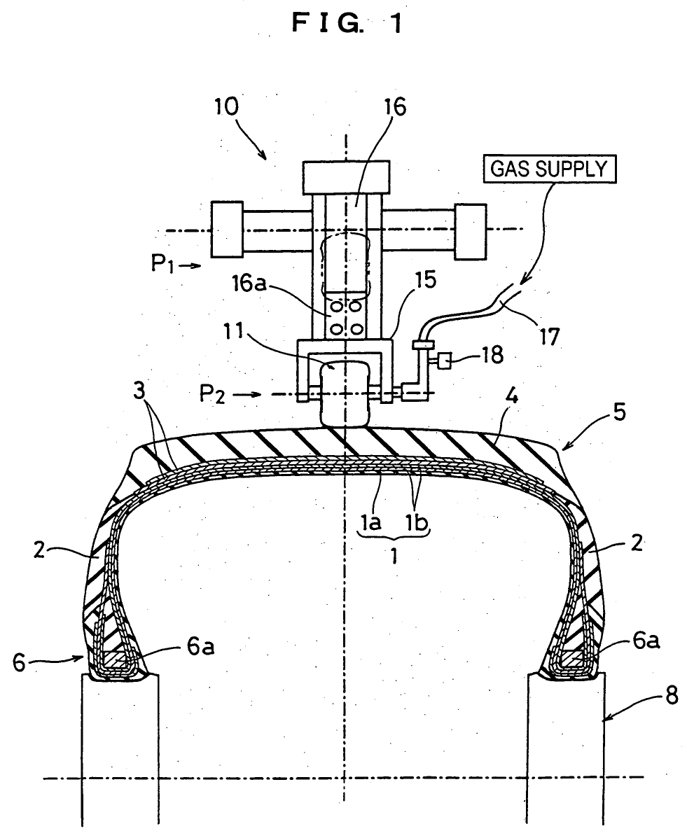

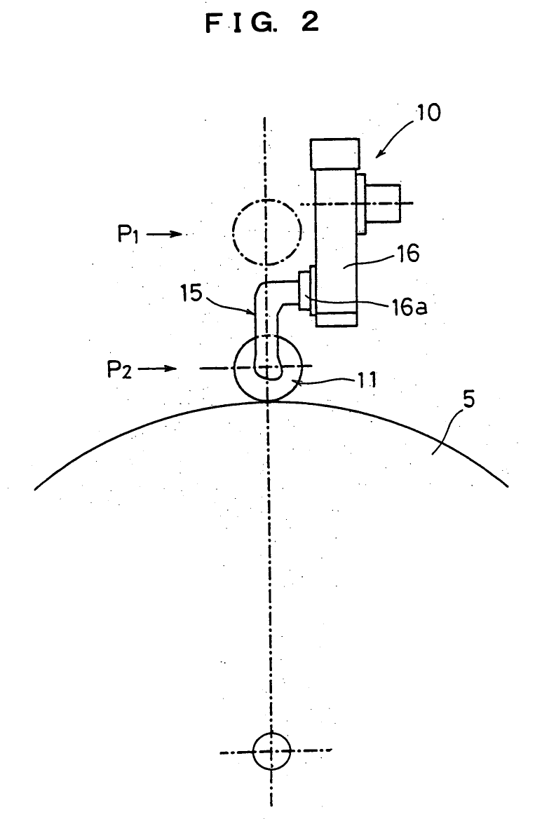

In FIG. 1 and FIG. 2, numeral 1 indicates a cylindrical inner-member laminate which is formed by stacking inner tire members including an inner liner 1a, carcass plies 1b, a chafer and the like; numeral 2 indicates side wall rubbers which are stacked on the inner-member laminate 1; numeral 3 indicates a belt which is one of the outer tire members stacked on the inner-member laminate 1 in a state that inner-member laminate 1 is deformed as bulged; numeral 4 indicates a tread rubber; and numeral 5 indicates a green tire as a stacked body of these tire members. Numeral 6 indicates bead portions and numeral 6a indicates bead cores. Numeral 8 indicates a rotary support body such as a building drum or the like which supports the inner-member laminate 1 as to be deformed as bulged, at its bead portions 6. The green tire 5 is built by stacking the outer tire members such as the belt 3 and the tread rubber 4, onto the inner-member laminate 1 in such bulged state. Other tire members such as rubber members forming partial reinforcing layers and a capping member are omitted from the explanation and the drawings.

The outer tire members such as the belt 3, the tread rubber 4 and the like may be stacked together separately with the inner-member laminate 1 as to be wound and annularly stacked on a rotary support body such as a building drum; and then to be stacked on an outer periphery of the inner-member laminate 1 supported on the rotary support body 8 as to be integrated with each other.

Numeral 10 indicates a stitcher device that, after stacking of the tire members, presses an outer peripheral surface of the green tire 5 supported by the rotary support body 8, for achieving bonding of the tire members with each other.

The stitcher device 10 of the present invention includes, as a pressing member applied to the tire members, a pneumatic-tire roller 11, which has a hollow inside filled with a gas and maintained with a given inner pressure.

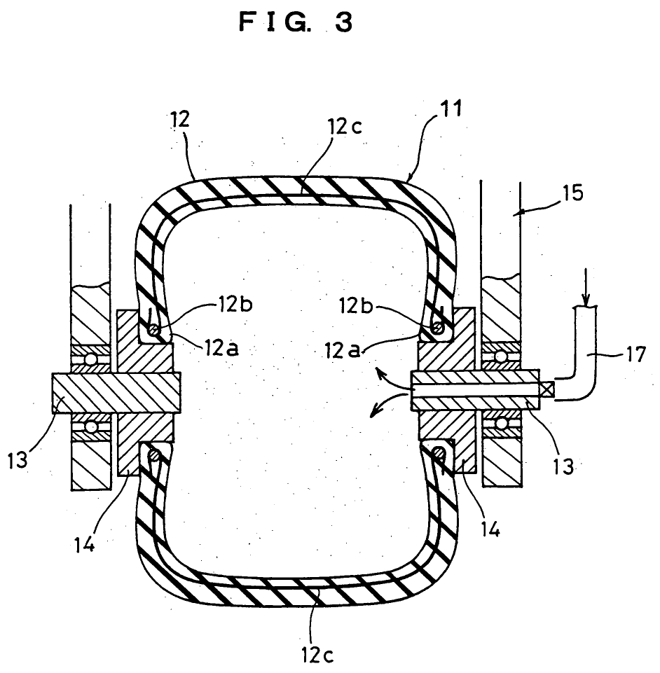

As shown in FIG. 3, main part of the pneumatic-tire roller 11 is a pneumatic tire 12 made of a rubber material that is formed in an annular shape having a substantially U-shaped cross section; in other words, a typical pneumatic tire is reduced in size and is slightly rounded to give the configuration of the pneumatic tire 12. Inner end portions 12a, 12b of the pneumatic tire 12 on its both sides are fixedly fitted on rim members 14 on rotatable support shafts 13 in a manner that the pneumatic tire 12 may be filled with a gas.

As a gas for filling the pneumatic-tire roller 11, air or a nitrogen gas is preferably used. An inner pressure of the gas is suitably set within a range of 0.5 to 5.0 kgf/cm², for example, corresponding to types or varieties, a material and the like of the tire members to be laminated.

The pneumatic tire 12 of the pneumatic-tire roller 11 has a width of 30 to 60 mm, preferably 40 to 50 mm, a diameter of 40 to 100 mm, preferably 50 to 80 mm, and a thickness of 2 to 4 mm; wherein the width is set considerably large compared to a width of a conventional stitching roller formed of a hard material such as metal or the like.

The pneumatic tire 12 may be solely formed of a rubber material. Nevertheless, in the drawing, annular reinforcing members 12b are embedded in the pneumatic tire 12 in its circumferential direction, at the inner end portions 12a on both sides. Further, cords 12c are embedded for reinforcement in the pneumatic tire 12 as to be extended between the inner end portions 12a.

The support shafts 13 on both sides on the pneumatic-tire roller 11 are pivotably supported on end portions of a bifurcated support 15, so that the support shafts 13 pivotably supported. As shown in FIG. 1 and FIG. 2, the support 15 is connected to an power-outputting member 16a of a servo actuator 16, for the pressing; and the servo actuator is a pneumatic cylinder or other cylinder device, or a linear motor, or other device capable to induce reciprocating motion. That is, the pneumatic-tire roller 11 is supported on the support 15 in a manner as being movable and displaceable in a direction substantially orthogonal to the outer peripheral surface of the green tire 5, which is a tire member laminate on the rotary support body 8.

Thus, the pneumatic-tire roller 11 is displaceable as to exert pressing for the bonding of the tire members, on outer peripheral surface of the green tire 5 upon actuation of the servo actuator 16; whereas the pneumatic-tire roller 11 is held at a certain original position P1 spaced apart from the outer peripheral surface of the green tire 5 during original state or non-operating time. A moving distance for the pressing may be suitably set, for example, depending on: an outer diameter of the green tire 5 as a laminate of the tire members; as well as a distance from the outer peripheral surface of the green tire 5 to an axis of the pneumatic-tire roller 11 at its original position P1; and the compression-deformation margin necessary for the press-wise bonding.

The servo actuator 16 is preferably set as follows; displacement in the pressing direction is controlled as to maintain a constant distance between the axis of the roller and the surface of the cylindrical laminate to be pressed, during the press-wise displacement of the pneumatic-tire roller 11. Consequently, the outer circumferential face of the green tire 5 is pressed at constant pressure, by displacing the shaft of the roller 11 in accordance with ups and downs of the outer circumferential face of the green tire 5.

The servo actuator 16 attaching the support member 15 is supported as movable in a widthwise or radial direction that is orthogonal to circumferential direction of the green tire 5. The servo actuator 16 is held as movable along the green tire 5 that is deformed as bulged into a toroidal shape, in its widthwise direction so that the pneumatic-tire roller 11 exert the pressing on the green tire 5 from its crown portion up to its shoulder portions, or up to side-wall rubber portions of the green tire 5 if necessary. As for moving the servo actuator 16, adoptable is a swiveling arm or either of various mechanisms that enables moving along the circumferential face of the green tire 5 in its widthwise direction.

As for supplying and filling the gas into the hollow inside of the pneumatic-tire roller 11, not-shown gas supply system is connected to a throughhole penetrating one of the shafts 13 of the roller 11. A pressure switch 18 is arranged at a portion of a supply line 17 from the gas supply system; for example, in vicinity of an inlet to the cavity. The pressure switch 18 detects a pressure at gas-filled cavity in the tire 12 and controls a supply of the gas into the cavity by use of detected pressure so as to keep constant the pressure in the tire 12. Further, the pressure switch 18 is controlled or adjusted so as to suitably set the pressure in the cavity, depending on types and varieties or materials and the like of the tire member to be or being stacked.

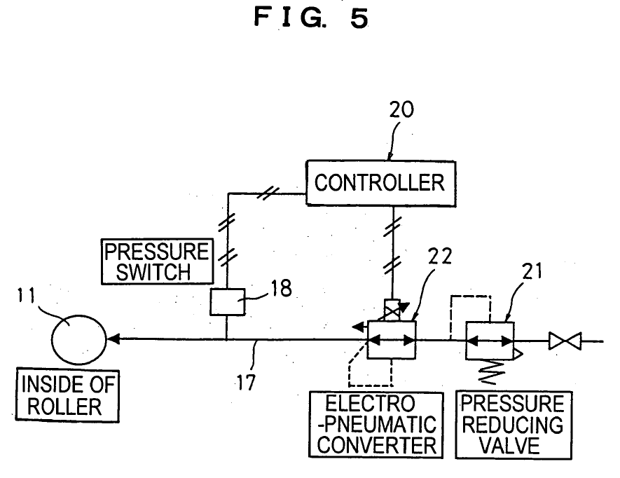

FIG. 5 shows a mechanism for controlling the pressure in the cavity. In the drawing, numeral 20 designates a controller; numeral 21 designates a pressure-reducing valve; and numeral 22 designates an electro-pneumatic converter. Based on the pressure detected at the pressure switch 18, the controller 20 generates a signal for activating the electro-pneumatic converter 22 and/or the pressure-reducing valve 21. In this way, the gas supply to the cavity is controlled as to accomplish ability for adequately adjusting the pressure in the cavity in conformity with nature of the tire member, as well as ability for keeping the pressure as constant.

In following, explanation is made to a manner and method for tire building in which the stitcher device 10 is used.

As in FIG. 1 and FIG. 2 for example, plurality of outer tire members such as the belt 3 and the tread rubber 4 are laid and stacked on the cylindrical inner-member laminate 1 while the inner-member laminate 1 is supported on the rotary support body 8 and is deformed as bulged to take a toroidal shape. The inner-member laminate 1 is previously formed by stacking the inner liner, the carcass plies and the like. After such laying and stacking of the outer tire members, thus obtained green tire being rotated and at the same time the stitcher device 10 exerts pressing on outer face of the tread rubber 4 as to achieve press-wise bonding among the outer tire members.

During the pressing, the servo actuator 16 effects displacement of the pneumatic-tire roller 11, which is a pressing member provided to the stitcher device 10; and the displacement being made in a manner that the pneumatic-tire roller 11 presses the outer face of the green tire 5 by keeping a certain compression-deformation margin or distance. The servo actuator 16 is controlled to make the displacement at constant force. During the displacement, the green tire 5 is rotated by rotating the support body 8, so that the displacement is gradually made in tune with such rotation as to achieve press-wise bonding all over the outer face while making a certain overlapping margins of the pressing.

Because the pressing member of the stitcher device 10 is the pneumatic-tire roller 11, substantially uniform pressure is exerted all over the being-pressed face in accordance with the pressure inside of the pneumatic-tire roller 11. Thus, partiality in pressing force is averted even though width of the roller 11 is larger than a corresponding roller formed of hard material in the conventional stitcher; thereby increasing of press-contacting area of the roller. Moreover, such increasing enables enhancement of speed of moving the roller in the widthwise direction during the pressing, so as to shorten a time for achieving the pressing on a large area all over the tire members. Consequently, a cycle time for the building is drastically decreased to, for example, about ½ to 1/10 of the conventional one. In this way, the productivity is increased.

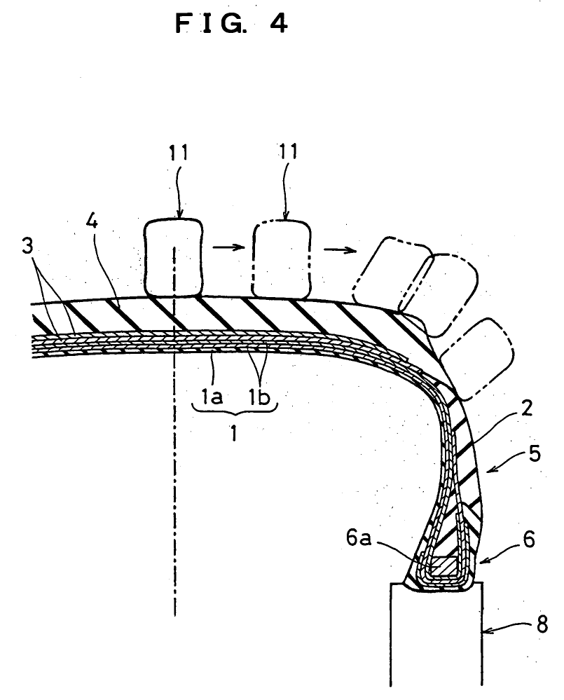

The pneumatic-tire roller 11 has a proper extent of elasticity that absorbs ups and downs, for example on outer face of the carcass plies on the cylindrical inner-member laminate 1 or on outer face of the outer tire members; so as to achieve a substantially uniform and reliable pressing for the bonding all over the outer face. Moreover, the servo actuator 16 is controlled as to keep constant the distance between axis of the pneumatic-tire roller 11 and the outer face of the inner-member laminate to be or being pressed. Under such controlling, the pneumatic-tire roller easily follows the ups and downs of the carcass plies or the ups and downs of the outer face of the outer members, by use of elastic deformation of the roller; thereby enabling the reliable and uniform pressing along the ups and downs. In short, because of the pressure of the gas filled into the pneumatic-tire roller 11 and of the reaction-force absorbability of the pneumatic tire that is mainly formed of the rubber material, uniform distribution of the contact pressure is achieved irrespective of local partiality of applied force, as shown in FIG. 4.

As illustrated in the figure, even when press-contact face of the pneumatic-tire roller 11 undergoes elastic deformation, exerting pressure is kept constant because the pressure switch detects pressure of the filled gas and controlling is made as to keep constant the inner pressure. Thus, the pressing is made in a well-balanced manner all over the tire members, for achieving the bonding of them. Accordingly, deformation and distortion that are arisen in profile of tire product is suppressed or alleviated; and hence, deterioration of the uniformity of tire product is suppressed. For example, radial force variation (RFV) and conicity (CON) that are measured in accordance with JIS D 4233 are improved by approximately 10%, compared with a conventional tire product.

Because the pressing force is made uniform, layout dimensions of the tire members do not deviate from designed ones. Thus, it is easy to cope with change or modification of design of tire's profile in a trial manufacturing stage whereby period required for the development of the tire is shortened to about ½ to ⅓ of the conventional ones.

In the above, explanation is made to a case where plurality of tire members are stacked and, thereafter, the tire members are pressed and bonded together, by the pressing on outer face of the tread rubber 4. Nevertheless, the pressing by use of the invention wise stitcher device 10 may be made at each completion of laying of one or plurality of the tire members including the inner tire members such as the inner liners 1a, the carcass ply 1b, as to achieve the bonding by the each pressing that is exerted by the pneumatic-tire roller 11.

The tire members for stacking, particularly rubber members solely consisting of a rubber material, may be built from rubber ribbons or strips in following manners. Rubber strips cut into a certain dimensions after extrusion molding in a certain profile may be used in same manner with the rubber ribbon extrusion molded in a certain width depending on the rubber member. The rubber ribbon is spirally wound up on a tire building drum as being partially and successively overlapped at margins of the ribbon, so as to form one of the tire member in a certain cross-sectional shape. By either of use of the ribbon and use of the strips, the invention-wise stitcher device 10 is applicable for pressing and bonding of the tire members as to achieve aforementioned advantageous effects.

The invention-wise stitcher device may also be used merely for forming one of the tire members, in the pressing operation after winding the rubber ribbon on a rotary support body such as the building drum.

As mentioned hereto, the invention-wise stitcher device is applicable to the pressing after stacking of tire members for forming the to-be-vulcanized green tire as to bond together the tire members; whereas the green tire is a laminate or stack of plurality of the tire members such as the carcasses having reinforced cords, the belt and the rubber members solely consisting of rubber materials. The invention-wise stitcher device is also applicable to the pressing after winding of rubber ribbon or laying of rubber strips for forming one of the tire members as to made bonding within the rubber ribbon or between the rubber strips; where the tire members being a rubber member such as an inner liner, a side wall rubber, and a tread rubber.

What is claimed is:

1. A method for building a green tire by stacking and bonding together a plurality of tire members, comprising:
laying one or more of the tire members on a rotary support body such as a building drum; and
press-contacting a press-contact part of a stitcher device on said one or more of the tire members on the rotary support while the rotary support being rotated, so as to bond together said one or more of the tire members, said press-contact part being a pneumatic-tire roller maintained with a certain level of inner pressure.

2. A method for building a green tire according to claim 1, further comprising:
forming a cylindrical laminate of inner tire members such as an inner liner, a carcass ply;
processing on the cylindrical laminate such as bead setting, turn-up folding of the carcass ply and laying of sidewall rubber;
deforming the cylindrical laminate as bulged to take a toroidal shape; and
laying of outer tire members such as a belt and a tread rubber before said press-contacting.

3. A method for building a green tire according to claim 1 or 2, further comprising:
forming a rubber member such as an inner liner, sidewall rubber and tread rubber by winding a rubber ribbon on the rotary support, before said press-contacting.

4. A method for building a green tire according to claim 1 or 2, further comprising:
adjusting the inner pressure depending on the tire member; and
controlling supply of gas to inside of the neumatic-tire roller as to maintanin the certain level of inner pressure during said press-contacting.

5. A method for building a green tire according to claim 3, further comprising:
adjusting the inner pressure depending on the tire member; and
controlling supply of gas to inside of the neumatic-tire roller as to maintanin the certain level of inner pressure during said press-contacting.

6. A stitcher device for pressing one or more tire members laid on a rotary support such as a building drum to achieve bonding of rubber in forming a green tire, comprising:
a pneumatic-tire roller as a part for press-contacting on outer face of the tire member as to achieve said bonding, the pneumatic-tire roller being maintained with a certain level of inner pressure.

7. A stitcher device according to claim 6, further comprising
an actuator attaching and holding the pneumatic-tire roller as to be movable in a direction substantially perpendicular to outer face of the tire member laid on the rotary support; and the pneumatic-tire roller being movable along and relative to the tire member, in a direction orthogonal to circumferential direction of the rotary support.

8. A stitcher device according to claim 7,
the pneumatic-tire roller being attached to moving part of the actuator; and
the actuator being controlled such that, during said press-contacting, a distance between axis of the pneumatic-tire roller and said outer face is maintained to be constant.

9. A stitcher device according to any one of claims 6 to 8, further comrising:
a gas supply system connected to a hollow inside of the pneumatic-tire roller; and
a pressure switch provided at a portion of a gas supply line from the gas supply system and capable of detecting the inner pressure;
gas supply through the pressure switch being controlled based on said detecting as to keep the inner pressure as constant.
